(19) United States
(12) Patent Application Publication
(10) Pub. No.: US 2025/0277809 A1
(43) Pub. Date: Sep. 4, 2025

(54) Probe-Based Instrument and Method Using Torsional Oscillation Sensing

(71) Applicant: Bruker Nano, Inc., Santa Barbara, CA (US)

(72) Inventors: Shuiqing Hu, Goleta, CA (US); Chanmin Su, Ventura, CA (US); Peter De Wolf, Saint Remeze (FR); Bede Pittenger, Santa Barbara, CA (US)

(21) Appl. No.: 19/067,291

(22) Filed: Feb. 28, 2025

Related U.S. Application Data
(60) Provisional application No. 63/559,580, filed on Feb. 29, 2024.

(51) Int. Cl. G01Q 60/38

(52) U.S. Cl. CPC G01Q 60/38

(57) ABSTRACT

A method and apparatus of operating an atomic force microscope (AFM) to measure a sample including using steady state AFM control and torsional oscillation (for example, torsional resonance (TR) Mode) excitation to select a torsional oscillation frequency or torsional oscillation frequency band for subsequent operation of the AFM in a force mapping/transient mode. The transient AFM mode may be one of PeakForce Tapping Mode, QI Mode and Force Volume Mode. In each cycle of probe-sample interaction in transient control mode there is a probe-sample free interaction interval and a probe-sample close proximity interval. TR Mode sensing using gated TR excitation during the close proximity interval of different regions of the probe-sample interaction is employed to improve resolution, for example, to differentiate atoms in graphite samples.

### CROSS-REFERENCE TO RELATED APPLICATIONS

This application claims priority under 35 U.S.C. § 1.119 (e) to U.S. Provisional Patent Application No. 63/559,580, filed on 29 Feb. 2024. The subject matter of this application is hereby incorporated by reference in its entirety.

### BACKGROUND OF THE INVENTION

### Field of the Invention

The present invention is directed to probe-based instruments, and more particularly, a new mode of operating a scanning probe microscope (SPM) that combines transient control with output signal amplification based on an induced torsional oscillation of the cantilever at proximate contact during selected regions of probe sample interaction.

### Description of Related Art

Several probe-based instruments monitor the interaction between a cantilever-based probe and a sample to obtain information concerning one or more characteristics of the sample. Scanning probe microscopes (SPMs), such as the atomic force microscope (AFM), are devices which typically use a sharp tip and low forces to characterize the surface of a sample down to atomic dimensions. More particularly, SPMs typically characterize the surfaces of such small-scale sample features by monitoring the interaction between the sample and the tip of the associated probe assembly. By providing relative scanning movement between the tip and the sample, surface characteristic data and other sample-dependent data can be acquired over a particular region of the sample, and a corresponding map of the sample can be generated. Note that “SPM” and the acronyms for the specific types of SPMs, may be used herein to refer to either the microscope apparatus, or the associated technique, e.g., “scanning probe microscopy.”

The atomic force microscope is a popular type of SPM. The probe of the typical AFM includes a very small cantilever which is fixed to a support at its base and has a sharp probe tip attached to the opposite, free end. The probe tip is brought very near to or into direct or intermittent contact with a surface of the sample to be examined, and the deflection of the cantilever in response to the probe tip's interaction with the sample is measured with an extremely sensitive deflection detector, often an optical lever system such as described in Hansma et al. U.S. Pat. No. RE 34,489, or some other deflection detector such as an arrangement of strain gauges, capacitance sensors, interferometric detection, etc.

Preferably, the probe is scanned over a surface using a high-resolution three axis scanner acting on the sample support and/or the probe. The instrument is thus capable of creating relative motion between the probe and the sample while measuring the topography or some other property of the sample as described, for example, in Hansma et al. U.S. Pat. No. RE 34,489; Elings et al. U.S. Pat. No. 5,226,801; and Elings et al. U.S. Pat. No. 5,412,980.

AFMs may be designed to operate in a variety of modes, including contact mode and oscillating flexural mode. In contact mode operation, the microscope typically scans the tip across the surface of the sample while keeping the force of the tip on the surface of the sample generally constant by maintaining constant deflection of the cantilever. This effect is accomplished by moving either the sample or the probe assembly vertically to the surface of the sample in response to sensed deflection of the cantilever as the probe is scanned horizontally across the surface. In this way, the data associated with this vertical motion can be stored and then used to construct an image of the sample surface corresponding to the sample characteristic being measured, e.g., surface topography. Alternatively, some AFMs can at least selectively operate in an oscillation “flexural mode” of operation in which the cantilever oscillates generally about a fixed end. One popular flexure mode of operation is the so-called TappingMode™ AFM operation (TappingMode™ is a trademark of the present assignee). In a TappingMode™ AFM, the tip is oscillated flexurally at or near a resonant frequency of the cantilever of the probe. When the tip is in intermittent or proximate contact with surfaces the oscillation amplitude will be determined by tip/surface interactions. The amplitude or phase of this oscillation is kept constant during scanning using feedback signals, which are generated in response to tip-sample interaction. More particularly, a feedback loop attempts to keep the amplitude of this oscillation constant to minimize the “tracking force,” i.e. the force resulting from tip/sample interaction. Alternative feedback arrangements keep the phase or oscillation frequency constant. As in contact mode, these feedback signals are then collected, stored, and used as data to characterize the sample. Note that “SPM” and the acronyms for the specific types of SPMs, including AFMs, may be used herein to refer to either the microscope apparatus or the associated technique, e.g., “atomic force microscopy.” In a recent improvement to the ubiquitous TappingMode™, called Peak Force Tapping® (PFT) Mode, discussed in U.S. Pat. Nos. 8,739,309 (the “'309 patent”), 9,322,842, 9,588,136, and 10,845,382, which are expressly incorporated by reference herein, feedback is based on force (also known as a transient probe-sample interaction force) as measured in each oscillation cycle. As in contact mode, these feedback signals are then collected, stored, and used as data to characterize the sample.

Independent of their mode of operation, AFMs can obtain resolution down to the atomic level on a wide variety of insulating or conductive surfaces in air, liquid or vacuum by using piezoelectric scanners, optical lever deflection detectors, and very small cantilevers typically fabricated using photolithographic techniques. Because of their resolution and versatility, AFMs are important measurement devices in many diverse fields ranging from semiconductor manufacturing to biological research.

A typical AFM system is shown schematically in FIG. 1. An AFM 10 employing a probe device 12 including a probe 14 having a cantilever 15 extending from a base 16 and supporting a tip 17. In a common configuration, probe 14 is often coupled to an oscillating actuator or drive 18 that is used to drive probe 14 at or near a resonant frequency of cantilever 15. Alternative arrangements measure the deflection, torsion, or other motion of cantilever 15, described further below. Probe 14 is often microfabricated with an integrated tip 17.

Commonly, an electronic signal is applied from an AC signal source or drive 18 under control of an SPM controller 20 to cause an actuator 19 to drive the probe 14 to oscillate (and/or to cause a scanner 24 to oscillate the sample). The probe-sample interaction is typically controlled via feedback by controller 20 that in the shown case controls the z-position of a sample 22 that is supported by scanner 24. As shown, scanner 24 can be a z-scanner or stage, or a scanner that provides movement in three orthogonal directions (xyz). Scanner 24 could also support probe assembly 12 (such as a piezoelectric tube scanner) to position tip 17 in “Z.” Notably, Z-actuator 19 may be formed integrally with cantilever 15 of probe 14 as part of a self-actuated cantilever/probe.

Often a selected probe 14 is oscqillated and brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26 (e.g., a quad photo-detector (QPD)). As the beam translates across detector 26, appropriate signals are processed, for example, using a low-pass filter (LPF) 28 coupled to a steady-state control engine 30 (e.g., an FPGA operating in steady-state mode such as TappingMode AFM) to determine RMS deflection and transmit a steady state control error signal to controller 20. In general, controller 20 generates control signals to maintain a relative constant interaction between the tip and sample (e.g., deflection of lever 15), by maintaining a setpoint characteristic of the oscillation of probe 14. For example, depending on operating mode, controller 20 is often used to maintain the oscillation amplitude at a setpoint value, A_{S}, to insure a generally constant force between the tip and sample. Alternatively, a setpoint phase or frequency may be used.

The vertical deflection signal may then be transmitted to a PI gain control block 32 which outputs signals indicative of sample properties. A workstation/computer 40 is also provided that receives the collected data from block 32 and manipulates the data obtained during scanning to perform point selection, curve fitting, distance determining operations, etc., which may be presented to the user via a display.

Torsional oscillation of the AFM probe has recently been more widely adopted in applications to achieve improved performance in measuring samples. In the AFM of FIG. 1, torsional resonance mode (TR Mode), a long known mode of AFM operation, is employed. In TR Mode, drive 18 is a TR Mode drive that oscillates the probe at or near a torsional resonance to allow detection of the torsional response to probe-sample interaction. Torsional resonance is used for both AFM control and detection of sample properties. TR Mode oscillation allows the detection of shear forces (e.g., friction) and shear force gradients, as well as more conventional forces, at increased imaging speed. TR Mode can achieve improved AFM imaging due at least in part to the fast response dynamics associated with the torsional resonance of the probe, as well as its ability to image multi-directional forces. TR Mode is described, for example, in U.S. Pat. Nos. 6,945,099, 7,168,301, and others, as well as new applications of TR Mode, for instance, TR-Tuna, U.S. Pat. No. 7,155,964.

More particularly, QPD 26 may transmit detected torsional/lateral motion of lever 15 to a band-pass filter that sends its output to a lock-in amplifier that generates information regarding changes in the torsional oscillation of probe 14. This information is processed by computer 40 which may be connected to a display for observation by the user.

To expand the capability of the AFM, some have used one or more of these techniques. For instance, monitoring torsional resonance has been used by groups to exploit its benefits in specific applications. In Kawagishi et al., Ultramicroscopy 91 (2002) 37-48, a method employing contact mode for feedback control of tip-sample interaction, along with monitoring lateral resonance of the probe, is disclosed. In this technique, dynamic friction, for example, can be measured. However, by employing steady state control such as contact mode which, for example, uses RMS values for amplitude detection, this dynamic friction method is limited in terms of AFM speed and resolution.

Improved AFM speed and resolution has been evolving, with a transient technique (e.g., monitoring force at each point of a deflection curve) such as PFT Mode being capable of atomic resolution. However, when operating in PFT Mode, for instance, the AFM can be susceptible to system noise, with less than ideal resolution. In another technique, torsional and lateral eigenmode oscillations are used for atomic resolution imaging under ambient conditions. In this case, a photothermal drive is employed in combination with monitoring torsional and lateral eigenmode oscillations of the probe. (Eichorn and Dietz, Scientific Reports, 12:8981 (May 28, 2022) Steady state AFM modes, such as Tapping Mode™ and contact mode, were used. Again, however, such steady state control techniques are susceptible to noise. For example, seismic vibrations, common during AFM operation, can substantially impact instrument resolution.

In a mode sometimes referred to as Torsional Force Microscopy (TFM), a scanning probe technique sensitive to dynamic friction, surface and shallow subsurface structure (e.g., of van der Waals stacks) can be revealed. See, Torsional Force Microscopy of Van der Waals Moires and Atomic Lattices, Pendharkar et al., Stanford Institute for Materials and Energy Sciences et al. (Aug. 16, 2023) In TFM, torsional motion of an AFM cantilever is monitored as it is driven at a torsional resonance thereof while a feedback loop maintains contact at a setpoint. While showing promise, TFM uses steady state scanning probe control modes such as contact mode (LFM/FFM/PFM) and Tapping Mode AFM that provide force detection with averaged data. In contact “steady state” control modes, lateral forces are substantial, and can vary. Such forces can couple into torsional resonance measurements and therefore sample properties. Moreover, in resonant “steady state” control modes (like TappingMode), the tip-sample interaction force is modulating/not constant, which can lead to coupling of complex forces into the torsional resonance measurements, potentially compromising sample property identification.

Continued improvement was desired for AFM performance, particularly when measuring sample properties at the atomic level. The ability to differentiate atoms in samples such as graphite samples has been a particular concern.

### SUMMARY OF THE INVENTION

Using transient or force mapping mode feedback and gated torsional oscillation, such as that in torsional resonance (TR) Mode, excitation to sense probe response, the preferred embodiments overcome drawbacks of the prior art in terms of speed of acquiring sample data, e.g., atomic resolution data, by amplifying the torsional oscillation signal. While the system and methods are often hereinafter described in terms of using TR Mode, the preferred embodiments are not so limited. While torsional oscillation is important, non-resonant operation is contemplated as well. Transient or force mapping mode AFM control is provided by preferably at least one of PeakForce Tapping Mode, QI Mode and FastForce Volume Mode.

In a preferred embodiment, a method of operating a scanning probe microscope (SPM) having a probe device including a tip that interacts with a sample includes controlling interaction between the probe device and the sample using a steady state SPM operating mode. Next, the method includes exciting torsional oscillation of the probe device by driving at least one of the probe device and the sample, and selecting at least one of a torsional oscillation frequency, a torsional oscillation frequency sweep and a torsional oscillation frequency band. Thereafter, control of the interaction between the probe device and the sample is switched to a force mapping or transient control mode. During transient interaction in the force mapping control mode, torsional oscillation of the probe device from the exciting step is driven based on the selecting step. The method then measures a torsional oscillation response during the driving step, and extracts a sample property based on the torsional oscillation response.

According to another aspect of this embodiment, the transient control mode is one of PeakForce Tapping Mode, QI Mode and Force Volume Mode.

According to another aspect of this embodiment, the exciting step includes driving one of the probe device and the sample.

In a further aspect of this embodiment, the exciting step moves the sample vertically inducing torsional motion of the probe, the probe having an offset tip disposed asymmetrically to a longitudinal centerline of a cantilever of the probe. In an alternative, the exciting step moves the probe vertically inducing torsional motion of the probe device.

According to yet another aspect of this embodiment, the measuring step generates a signal, and the signal is amplified by at least one of the shape of the probe and an offset of a tip of the probe from a longitudinal centerline of a cantilever of the probe.

In another aspect of this embodiment, the selecting step includes selecting a torsional resonance, wherein the sample has a surface with a hardness, and wherein the selected torsional resonance is greater the harder the sample surface

According to a further aspect of this embodiment, the driving step includes using a drive gated to a proximate contact point corresponding to a selected region of the transient mode force curve. The drive may generate a square wave or other suitable waveform.

In yet another aspect of this embodiment, the probe and the sample do not contact each other during the interaction between the probe and the sample in the transient control mode.

According to another preferred embodiment, a scanning probe microscope (SPM) scanning probe microscope (SPM) having a probe device including a tip that interacts with a sample includes a drive to provide relative oscillation between the probe device and the sample, and a controller to control the interaction between the probe device and the sample. A torsional oscillation drive is employed to oscillate the probe device and operation is controlled to first select at least one of a torsional oscillation frequency and a torsional oscillation frequency band while operating the SPM in a steady state SPM operating mode. Then switch control of interaction between the probe device and the sample to a transient control mode. During transient interaction, causing the drive to drive torsional oscillation of the probe device based on a selected torsional oscillation frequency and torsional oscillation frequency band. A torsional oscillation response is then determined while driving torsional motion, and a sample property based on the torsional oscillation response is extracted.

In another aspect of this embodiment, the transient control mode is one of PeakForce Tapping Mode, QI Mode and Force Volume Mode.

According to a further aspect of this embodiment, a TR drive moves the sample inducing torsional motion of the probe device.

In yet another aspect of this embodiment, one of the oscillation drive or oscillation detection is gated to a proximate contact point corresponding to a selected region of the transient mode force curve. Moreover, the selected region may correspond to one of an approach, a hold and a withdraw.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic illustration of a Prior Art atomic force microscope AFM;

FIG. 2 is schematic illustration of probe-sample interaction according to a preferred embodiment, using a transient AFM operating mode such as peak force tapping and gated torsional resonance sensing;

FIG. 3 is a schematic illustration of tip-sample interaction including the close proximity interval, and the tip/sample interaction free interval, of probe-sample interaction, according to a preferred embodiment;

FIG. 4 a schematic illustration of probe-sample proximate contact point and proximate contact area, according to the preferred embodiments;

FIGS. 5A to 5D are plots depicting flexural resonance amplification and torsional resonance amplification;

FIGS. 6A-6H are plots illustrating gating torsional resonance excitation to different regions of the probe-sample interaction, according to the preferred embodiments;

FIG. 7 is a block diagram of an AFM employing transient AFM control with TR Mode sensing, according to a preferred embodiment driving the probe to excite torsional resonance;

FIG. 8 is a block diagram of an AFM employing transient AFM control with TR Mode sensing, according to a preferred embodiment driving the sample to excite torsional resonance;

FIG. 9 is a flow chart illustrating a method of operating an AFM employing transient AFM control with TR Mode sensing, according to the preferred embodiments; and

FIGS. 10A-10C are schematic illustrations of several means to excite torsional resonance at probe-sample proximate contact point/proximate contact area shown in FIG. 4;

FIGS. 11A-11D are schematic illustrations of the geometry of probe cantilevers used for sensing changes in flexural resonance (tip symmetric); and

FIGS. 12A-12D are schematic illustrations of the geometry of probe cantilevers used for sensing changes in torsional resonance (tip asymmetric), including tip geometry in FIG. 12D.

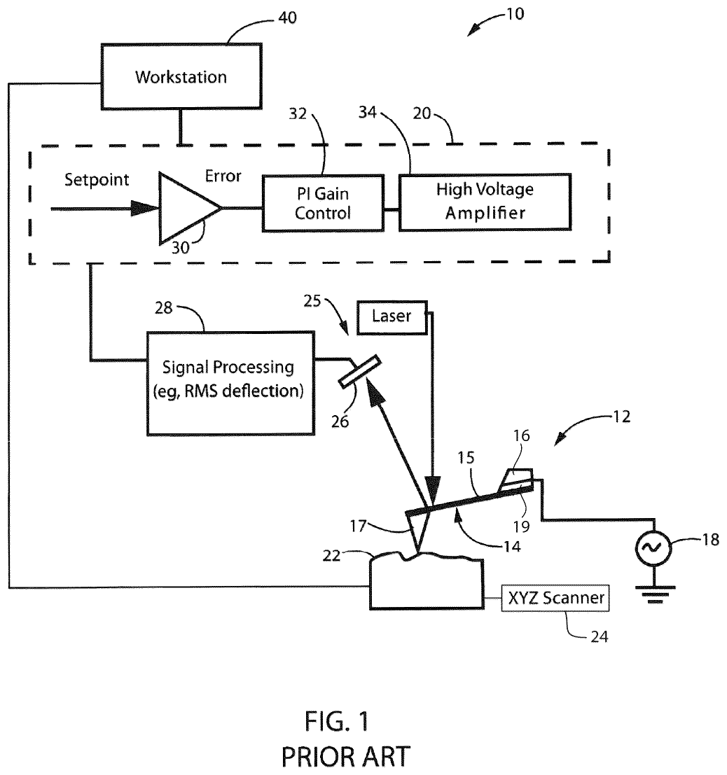

### DETAILED DESCRIPTION OF THE PREFERRED EMBODIMENTS

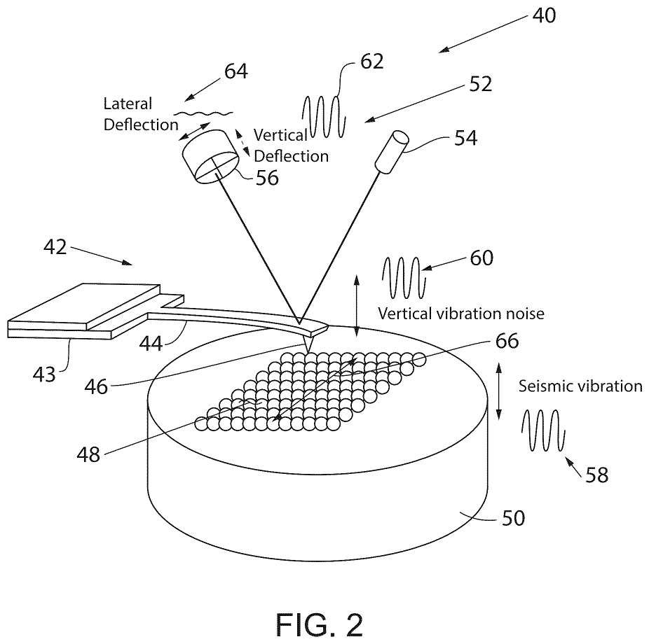

Imaging, such as atomic level imaging, in the preferred embodiments is achieved by taking advantage of several modes of AFM operation, preferably employing a transient AFM control mode while using TR Mode to sense the response of the probe when the probe is in close proximity to the sample. In this way, the present AFM is able to minimize damaging resolution effects due to phenomena such as seismic vibration noise. A schematic set-up is shown in FIG. 2 in which an AFM 40 includes a probe assembly 42 having a base 43 and a microcantilever 44 extending therefrom and having a distal end supporting a tip 46. In this example, a sample 48 resides on a scanner 50. Seismic vibration mostly in the Z direction, common in a typical AFM system, can lead to seismic vibration noise that can contaminate the AFM's vertical deflection signal generated by, e.g., a conventional optical beam-bounce detection scheme 52 employing a laser diode 54 and a quadrant photodetector 56. Note that other detection schemes are contemplated, such as interferometric detection. The vertical deflection signal is used to generate an image of one or more properties of the sample, such as topography, and this noise can significantly limit resolution. More particularly, seismic vibration, illustrated as periodic signal 58, appears as vertical vibration noise (periodic signal 60 representing, for example, 10-20 pm of noise) in the vertical deflection signal 62. This noise 60 contaminates the vertical deflection signal 62 reducing high resolution signal-to-noise ratio and the AFM's ability to precisely acquire sample-relevant data on the atomic scale.

Notably, however, seismic noise does not impact lateral or torsional deflection of the probe assembly in the same way. Shown schematically in FIG. 2, while the lateral noise 66 due to seismic vibration can be substantial (100-200 pm, for example), the amplitude of the lateral deflection signal 64 is not substantially impacted by this seismic vibration, in contrast to the vertical deflection signal 62. Importantly, lateral deflection is much less sensitive to the seismic noise, thus allowing atomic/high resolution AFM imaging to be more readily achievable, even enabling differentiation of graphite atoms.

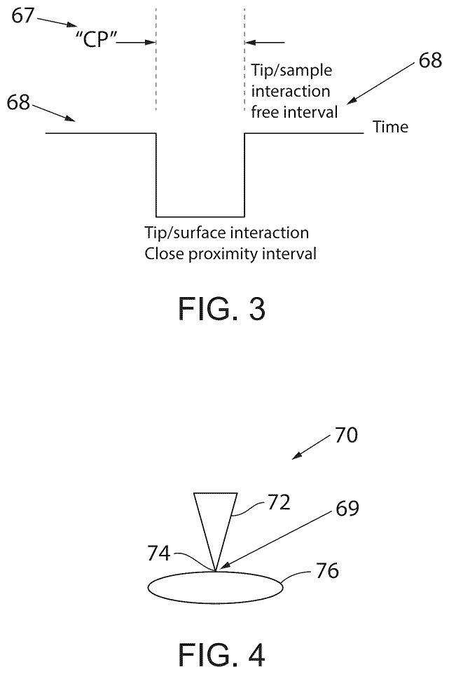

In the preferred embodiments, TR Mode is employed to sense changes in torsional oscillation of the probe, while vertical tip-sample interaction is controlled, preferably, using transient mode feedback, namely, PFT Mode, QI Mode or Force Volume mode. A schematic illustration of tip-sample interaction in PFT Mode is shown in the aforementioned '309 patent. As known in the field and described in the '309 patent, as the probe-sample separation is oscillated, and the probe nears the sample, it begins to experience forces between the tip and the sample surface. Namely, prior to actual tip-sample physical contact, the tip will begin to experience van der Waals forces. From this time until the tip contacts and releases from the sample surface, marked “CP” in FIG. 3, the tip-sample interaction occurs over a close proximity interval 67. Probe-sample interaction outside time CP is defined as the free interval 68, for purposes of the preferred embodiments.

In this regard, the probe-sample proximate contact point and contact area during the close proximity interval (CP) are of interest. Shown schematically in FIG. 4, a proximate contact point 69 between a probe 70 having a tip 72 with an apex 74 and a sample 76 is the distance between tip apex 74 and the sample surface when this distance is less than, for instance, 10 nm. Initial contact is due to short range probe-sample interactions, for example, van der Waals forces. Probe-sample proximate contact area is the area of contact determined by the radius of apex 74 from 1 nm to 30 nm, for instance.

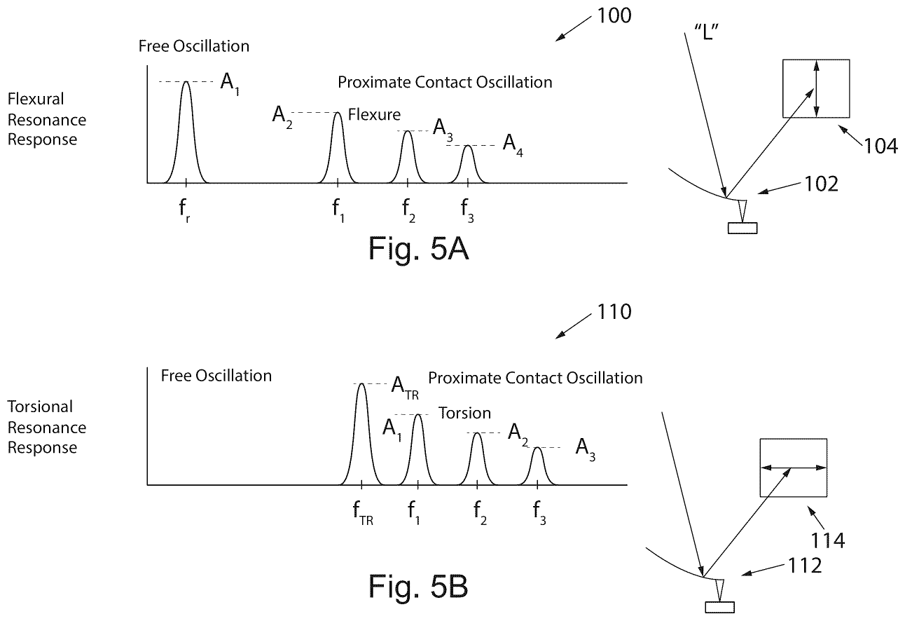

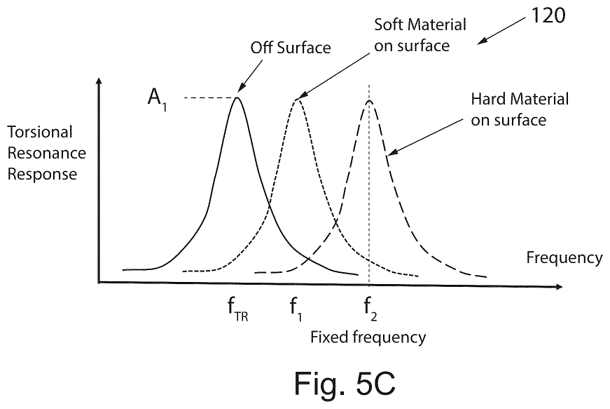

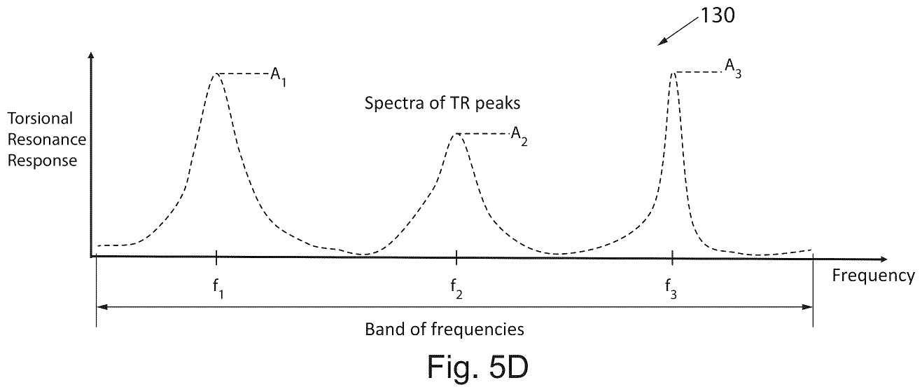

Turning to FIGS. 5A and 5B, an illustration of the preferred embodiments in which a TR Mode signal (e.g., lateral deflection) is used in the detection scheme to amplify changes in probe-sample interaction during the close proximity interval (FIG. 3). Referring initially to FIG. 5A, the flexural resonance response 100 includes a free oscillation amplitude A₁ at a resonant frequency fᵣ. When in proximate contact as defined previously, tip-surface interaction at a harmonic, frequency f₁, is amplified with a flexural amplitude A₂. Subsequent harmonics or eigenmodes, f₂ and f₃ in this case, yield an amplified probe response at reduced amplitudes A₃ and A₄. The measured deflection using a beam “L” directed toward a reflective backside of a cantilever of a probe 102 so it reflects toward a quadrant photodetector 104 is illustrated as vertical movement on the photodetector.

In FIG. 5B, the torsional resonance response 110 includes a free oscillation amplitude ATR at a resonant frequency f_{TR} (greater than the fundamental flexural resonance frequency fᵣ). When in proximate contact as defined previously, tip-surface interaction at a harmonic, frequency f₁, is amplified with a torsional amplitude A₁. Subsequent harmonics or eigenmodes, f₂ and f₃ in this case, yield amplified probe responses with torsional oscillation amplitudes A₂ and A₃. The measured deflection using a laser beam “L” directed toward a reflective backside of a cantilever of a probe 112 so it reflects toward a quadrant photodetector 114 is illustrated as horizontal movement on the photodetector, as shown. FIG. 5C, similar to FIG. 5B, illustrates proximate contact torsional resonance response 120 for an exemplary experiment. The off-surface or free oscillation resonance occurs at frequency f_{TR}, having an amplitude A₁. As noted, the proximate contact torsional resonance frequency is higher than the free oscillation resonance (f₁>TR), and harder materials such as silicon having a large Young's modulus, e.g., 130.2 GPa to 187.5 GPa, have a higher proximate contact resonance (f₂>f₁) than when measuring softer surfaces. In this example, we focus on hardness/modulus, but a variety of properties can be measured. For example, damping of the probe can be related to visco-elastic properties (e.g., through the Q factor). Frictional and/or shear properties, as well as other properties from the interactions, may be also extracted.

FIG. 5D further illustrates TR sensing by tuning to resonance using a band of frequencies. By using a band of frequencies, the user may have a choice of TR resonances of varying amplitudes of a torsional resonance response 130, each useful depending on application. For instance, resonances f₁, f₂, f₃ may have amplitudes A₁, A₂, A₃, respectively, each yielding useful sample information. Frequency f₁ may correspond to the fundamental resonance frequency of the flexure and torsional resonance, while f₂ and f₃ correspond to the overtones of the flexure and torsional resonances. Overall, the goal is to collect data regarding the full resonance spectrum, over a wide frequency range, such that multiple torsional resonance eigenmodes are covered. Each eigenmode can hold a piece of (complementary) information about the sample. Measurements beyond using a single torsional resonance are also possible.

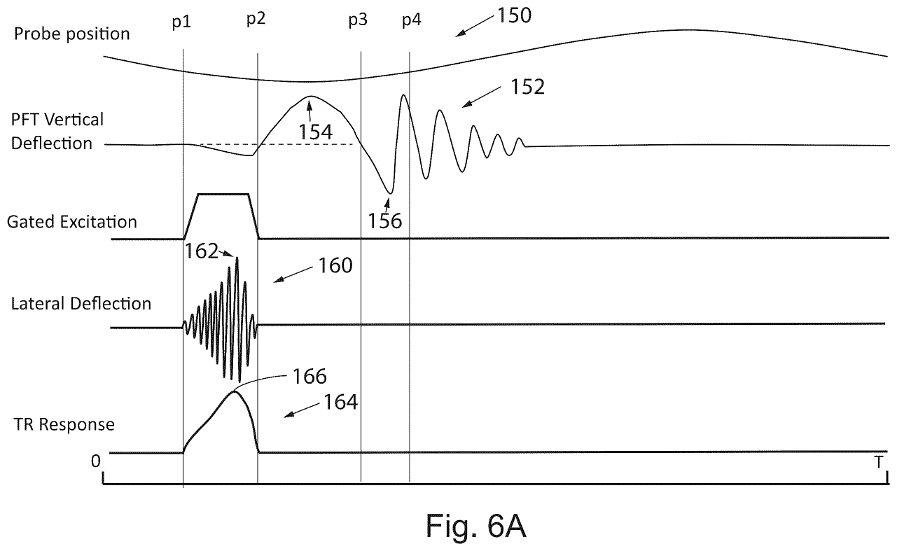

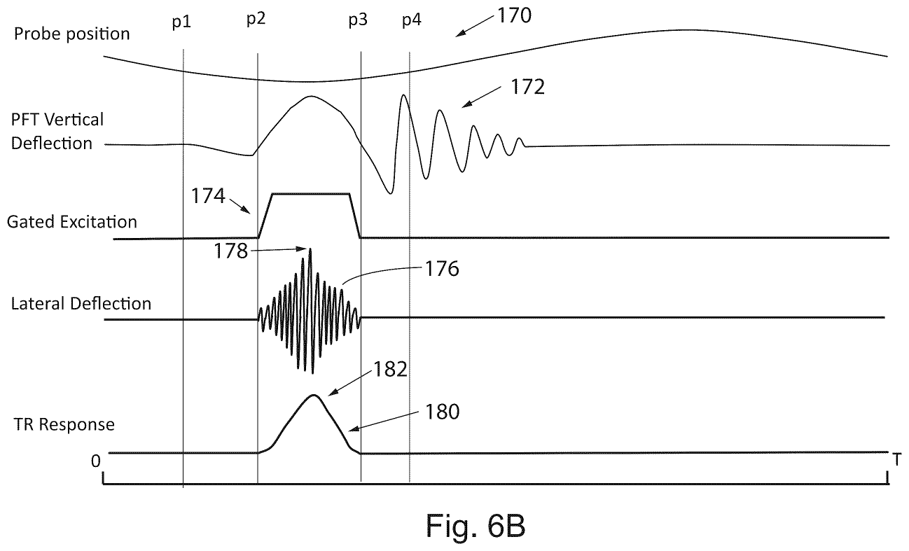

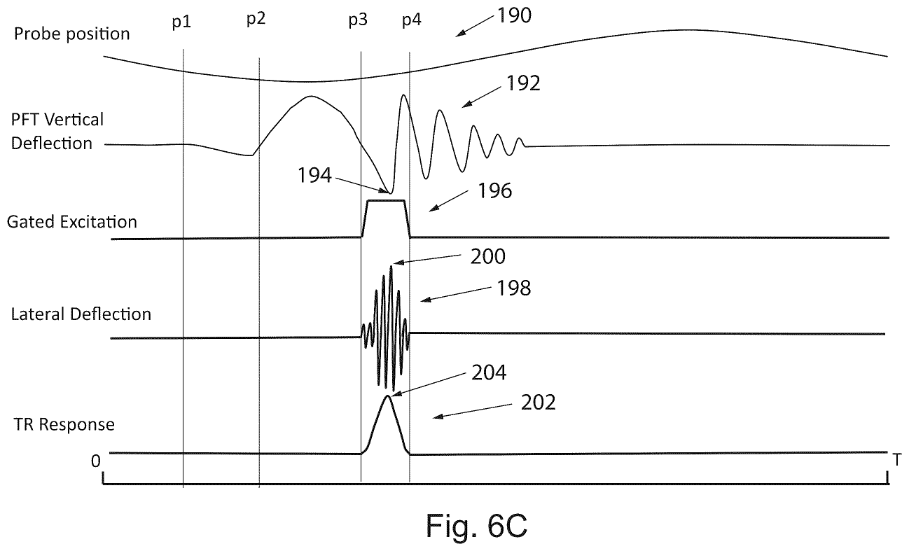

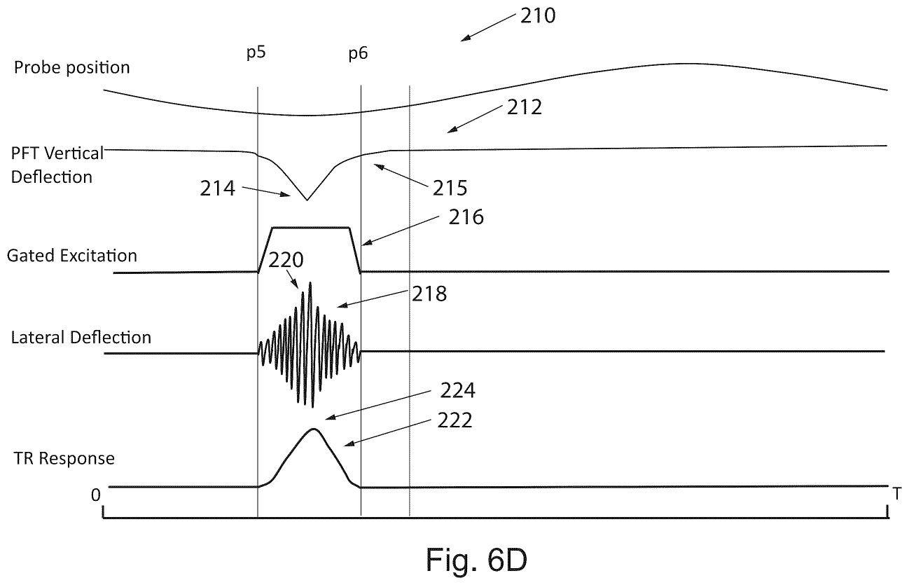

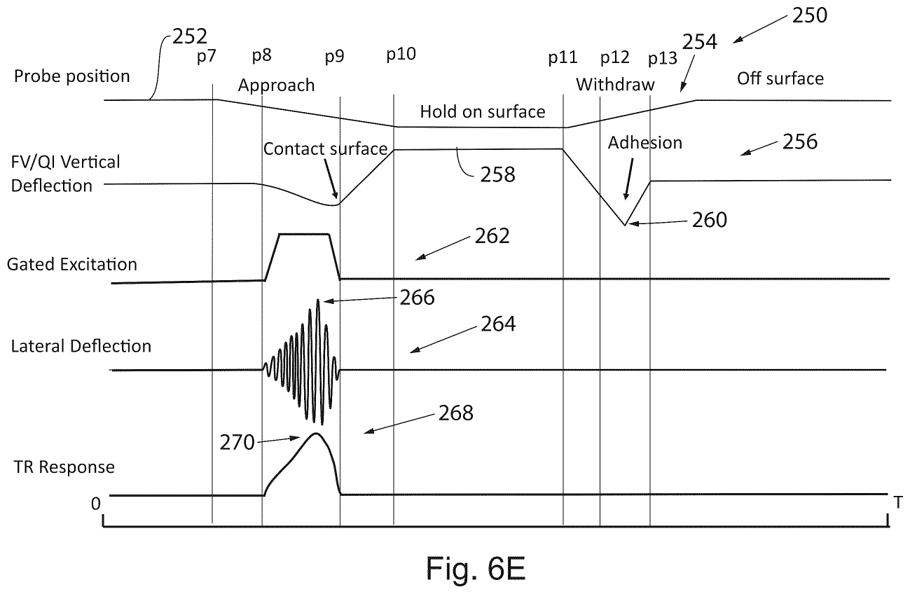

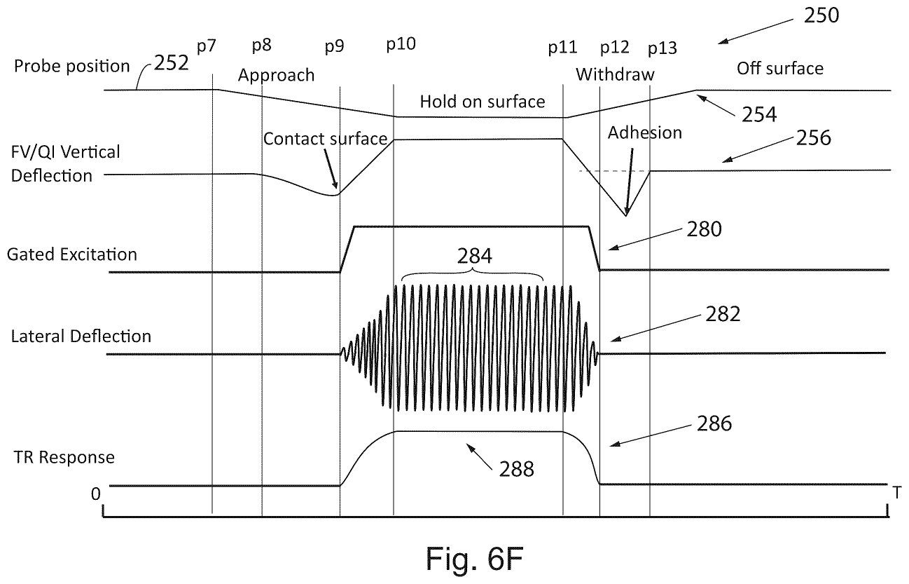

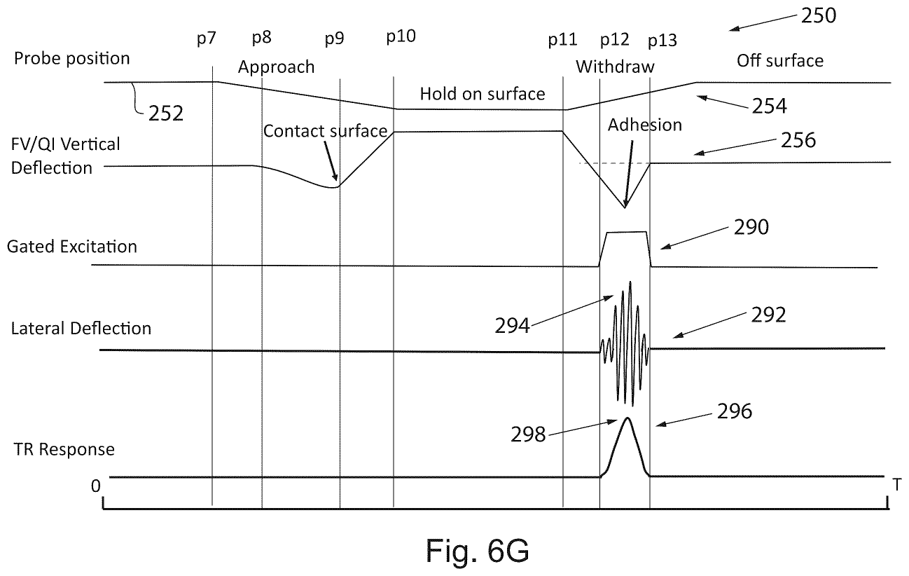

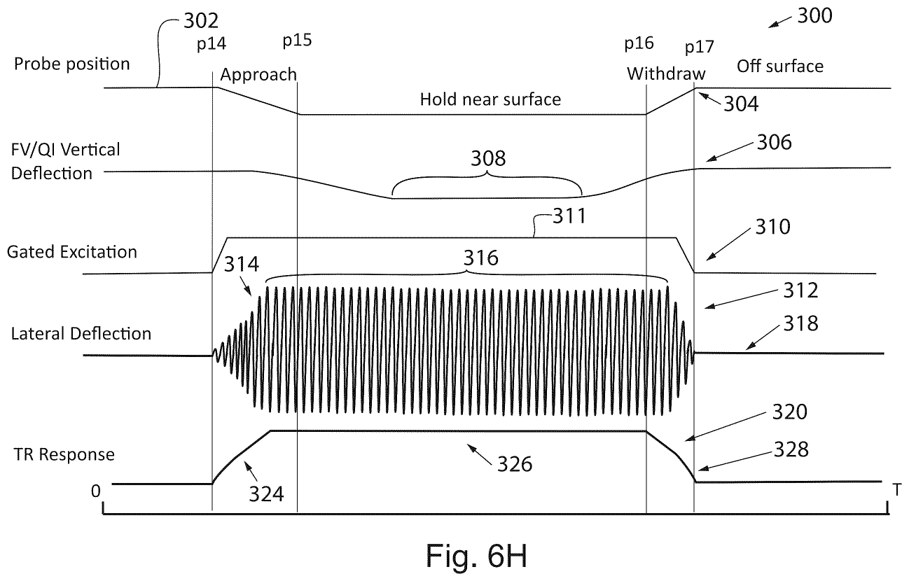

A graphic illustration of the operation of the preferred embodiments is shown in the series of plots in FIGS. 6A-H. For AFM control, transient mode feedback is used, with FIGS. 6A-D employing Peak Force Tapping (PFT) Mode, and FIGS. 6E-6F illustrating alternate transient modes such as Force Volume Mode, QI-mode and DT Sense mode (each of these modes marketed under trademarks of Bruker Instruments, Inc.). Starting with FIG. 6A, periodic oscillating probe motion 150 relative to a sample is shown along with PFT vertical deflection 152. At time p₁, the probe begins to experience attractive forces, such as van der Waals forces as the probe snaps to contact between p₁ and p₂. The probe-sample separation is reduced further as force between tip and sample increases leading to positive deflection, starting at p₂ and continuing p₃, prior to the oscillating drive pulling the tip away from the surface at 154 in plot 152. Tip and surface remain in contact, with positive deflection turning negative starting at time p₃ as the tip adheres to the sample surface. At point 156 of the vertical deflection, the tip releases from the sample surface, and probe oscillation rings down at p₄ before another cycle of probe-sample interaction begins.

To implement torsional resonance sensing according to this preferred embodiment, gated excitation during the time period p₁-p₂, which is the close proximity interval (proximate contact), is initiated. In transient modes, proximate contact (at p₁ in this case) is known precisely and torsional resonance (TR) excitation is initiated to drive the probe at a torsional resonance thereof. It is shown as a square wave in plot 158 (trapezoidal, ramp on either side) corresponding to this attractive force region of the probe-sample interaction, but the drive may be any suitable waveform. TR excitation is terminated to substantially coincide with the deflection of the probe going positive after snap to contact.

The lateral deflection of the probe during gated excitation is shown in plot 160. Maximum signal 162 occurs as the probe is driven further “into” the sample as deflection reverses from negative to positive prior to the probe deflection crossing at about the zero axis at p₂. The torsional resonance response (TR response) 164 follows the gated TR excitation. The maximum TR response corresponds to the maximum lateral deflection 162 of signal 160 so as to tune the torsional resonance. Due to the presence of the attractive van der Waals forces, electrostatic and magnetic forces, for example, the TR resonance amplitude (or magnitude) would be reduced from the free TR resonance. If the TR drive frequency is tuned to this resonance, the TR excitation is excited during the attractive force region and becomes the method to detect the attractive force, useful as understood in the field.

In this way, improved atomic resolution, for example of graphite atoms, can be achieved. It is the sensitive high frequency torsional deflection that helps make this possible along with the transient AFM control method to allow precise determination of proximate contact between the probe tip and sample. A transient control method such as PFT Mode facilitates the measurement while providing AFM operational speeds that are state of the art. Gated torsional resonance excitation and response measurement can improve signal-to-noise ratio (SNR) by approximately 2-5 times. Torsional resonance response may include TR amplitude, phase and TR frequency.

Turning next to FIGS. 6B-6D, gating torsional excitation of the probe to different portions of the PFT vertical deflection can yield different information regarding the sample. In FIG. 6B, the probe position 170 and PFT vertical deflection 172 signals are the same as those of FIG. 6A. In this case, the torsional excitation signal 174 is gated between p₂ and p₃, that is, between the point the deflection turns positive after snap-to-contact (p₂) and when it turns negative as the probe is withdrawn from the sample during the PFT oscillation cycle and adheres to the sample surface, also known as the contact repulsive force. The lateral deflection is shown in plot 176 and the corresponding TR response is represented by signal 180. The lateral deflection 176 has a maximum at about point 178 when the PFT oscillation cycle reverses and starts to pull the tip away from the sample. The corresponding response of the TR oscillation is shown at time 182 of signal 180 in FIG. 6B. The information obtained from gating the TR excitation in this p₂-p₃ region is indicative of the torsional resonance response during the contact resonance region. This can be the sample material property, but could also be the torsional vibration from the sample such as the photothermal expansion due to IR excitation.

In FIG. 6C, the probe position 190 and PFT vertical deflection 192 signals are the same as those of FIGS. 6A and 6B. In this case, the torsional excitation signal 196 is gated between p₃ and p₄, that is, between the point the deflection turns negative as the tip is further withdrawn from the sample surface during the PFT oscillation cycle, yet remains in contact with the sample (i.e., the tip adheres/sticks to the sample), also known as the adhesion force. As shown at point 194 of the PFT vertical deflection, the tip releases from the sample surface and the oscillation of the probe/cantilever thereafter rings down. It is this release that provides the highest amplitude (at point 200) of the lateral deflection 198. The corresponding TR response is represented by signal 202. The maximum of the TR oscillation 202 is shown at time 204 in FIG. 6C, corresponding to the largest lateral deflection amplitude at time 200. The information obtained from gating the TR excitation in this p₃-p₄ region is indicative of the TR responses such as amplitude, phase and frequency shift due to tip-sample adhesion forces.

Next in FIG. 6D, PFT mode is again used for AFM control, but in this case force control is employed to ensure the tip does not come in contact with the sample. In this case, long range forces, such as electrostatic and magnetic forces, are used to control tip-sample separation/interaction, with appropriate setpoints to prevent contact between the probe and the sample. Probe oscillation signal 210 is the same sinusoidal oscillating drive as the previous embodiments of FIGS. 6A-6C. PFT vertical deflection signal 212 when triggering on, for example, electrostatic forces between tip and sample (proximate contact defined in terms of such long range forces) in a time region between p₅ and p₆ initially is similar to the deflection caused by van der Waals force of the previous embodiments. Maintaining the setpoint force in the range of such forces yields a PFT vertical deflection curve 212 such as that shown. In this case, the deflection exhibits a negative maximum at time 214 before the withdraw portion of the oscillating PFT drive. When the electrostatic forces between tip and sample cease, the deflection returns to its baseline (at about time 215). In operation of this preferred embodiment, gated excitation signal 216 is applied to drive the probe into torsional resonance between times p₅ and p₆. The lateral deflection signal 218 exhibits a maximum 220 at approximately the center of the square wave excitation signal 216 and the maximum negative vertical deflection 214. The corresponding torsional resonance response is shown with signal 222, that has a maximum amplitude at time 224 substantially corresponding to the maximum lateral deflection. Due to the presence of the attractive van der Waals forces, electrostatic and magnetic forces, the TR resonance would be reduced from the free TR resonance. If the TR drive frequency is tuned to this resonance, the TR excitation can be excited during the attractive force region and become a method for detecting the attractive force.

In FIGS. 6E-6H, non-PFT transient modes are alternatively employed. These modes include Force Volume Mode, QI Mode and DT Mode and are described more fully at Bruker's web address, www.bruker.com. In these modes, rather than using a sinusoidal drive signal for AFM control, probe position (represented by plot 250) is precisely controlled. Turning to FIG. 6E, the probe position using a controlled drive in one of these modes is shown. After initially positioning the probe relative to the surface at time 252, the AFM operational mode at time p₇ is started in an Approach region p₇-p₁₀, for example. Thereafter the Approach may be held relative to the surface to maintain a substantially constant tip-sample surface separation between times p₁₀ and p₁₁. A withdraw region is then initiated at p₁₁ until the tip starts to come off the surface at p₁₃, finally settling off-surface at time 254.

The corresponding vertical deflection is shown with signal 256 in each of FIGS. 6E-6H. More particularly, deflection is zero during the initial region, between times p₇ and p₈, of the Approach. Then, attractive forces (such as van Der Waals, etc.) deflect the tip toward the sample between times p₈ and p₉, at which point the tip contacts the surface at time p₉ (snap to contact). The Approach region continues between times p₉ and p₁₀ and the tip deflection reverses, turning from negative to positive as the probe tip is driven further in to the sample (notably, the tip may not penetrate a sufficiently hard sample surface; cantilever bends as the separation between the base of the probe and the sample surface narrows). At a setpoint force/deflection, probe position is held vis-à-vis the sample surface. The duration of this “Hold” is set by the user, defined between p₁₀ and p₁₁, as vertical deflection is constant at amplitude 258. Thereafter, the tip is withdrawn moving either the sample or the probe in “Z, as deflection starts to go negative just before p₁₂ which substantially corresponds to zero deflection. Continuing the Withdraw operation, the tip “sticks” to the sample until time 260 between p₁₂ and p₁₃ in the vertical deflection figures. At time 260 the tip releases from the sample and deflection returns to the baseline at p₁₃ as the Withdraw region continues until the tip is clearly off surface at time 254.

By controlling probe-sample position in transient mode in this way, TR excitation can be gated to different regions of interest. In FIG. 6E, the TR excitation 262 is gated at the tip-sample attractive force region (proximate contact), triggered to end at tip-surface contact. The corresponding lateral signal 264 having a maximum amplitude 266 at or just before snap-to-contact (see vertical deflection signal). The TR response 268 ramps until it shows a corresponding maximum amplitude 270. The torsional resonance may be tuned in this way to determine attractive forces including van der Waals, electrostatic and magnetic forces. Due to the presence of the attractive van der Waals forces, electrostatic and magnetic forces, the TR resonance would be reduced from the free TR resonance. If the TR drive frequency is tuned to this resonance, the TR excitation can be excited during the attractive force region and become a method for detecting the attractive force. Turning to FIG. 6F, the excitation 280 is gated to correspond to the time region p₉ to p₁₂. Lateral deflection signal 282 begins to build as Approach continues after contact and reaches a maximum amplitude during the Hold, region 284. During Withdraw, lateral signal is reduced to the baseline at the termination of the square wave excitation 280. The TR response signal 286 is at a maximum amplitude 288 substantially corresponding to the maximum lateral deflection signal region 284 between p₁₀ and p₁₁. This response provides the contact repulsive force. This is similar to FIG. 6B, but the AFM control is using employing force volume mode instead of Peak Force Tapping mode, yet the TR response is essentially the same.

In FIG. 6G, the excitation 290 is gated to correspond to the time region p₁₂ to p₁₃. Lateral deflection signal 292 begins to build as the Withdraw (probe position plot 250) continues and reaches a maximum amplitude 294 at about the inflection point of the deflection signal 256 where the adhesion force is at a maximum 294, i.e., prior to the tip releasing from the sample surface at p₁₃. The lateral deflection signal is reduced to the baseline at the release point, corresponding to termination of the square wave excitation 290. The TR response signal 296 is at a maximum amplitude 298 substantially corresponding to the maximum lateral deflection signal point 294 (max adhesion) between p₁₂ and p₁₃. This case is similar to that in FIG. 6C, with force volume mode being used for AFM control.

Finally, in FIG. 6H, similar to the embodiment of FIG. 6D except using a transient mode other than PFT mode, such as force volume mode or QI-mode, probe-sample interaction is measured without the tip touching the sample. In this embodiment, probe position signal 300 begins at position 302, with corresponding zero probe deflection from baseline. An Approach is initiated at p₁₄ and continues to time p₁₅. As tip and sample get closer, attractive force begin to bend the lever of the probe. Bending/deflection continues until a user-defined hold at time p₁₅. The probe position is held constant between p₁₅ and p₁₆ as attractive forces continue to bend/deflect the probe cantilever until reaching a maximum negative deflection amplitude at 308 of the vertical deflection plot 306 (probe tip still not in contact with the sample surface). Thereafter, the probe-sample separation (i.e., probe position) is increased in a Withdraw operation between p₁₆ and p₁₇ until the probe is “Off surface” at region 304 starting at p₁₇. In this embodiment, gated TR excitation is initiated at p₁₄ using a suitable drive signal (e.g., square wave 310 with amplitude 311), and terminated at the end of the Withdraw (known in transient SPM control modes). The lateral deflection response is shown with plot 312, with the corresponding TR response (plot 320). Lateral deflection, and the corresponding TR response builds at 314, 324, respectively, during Approach, and reaches a maximum 316, 326 prior to maximum vertical deflection (308 of signal 306) prior to returning to its baseline 318 at time p₁₇ (“Off surface”). The TR response 320 begins to fall in region 328 upon initiation of the Withdraw. The decrease in lateral deflection 312 lags slightly, falling on the termination of the gated TR excitation signal 310 (not a perfect square wave). Notably, the hold function (for example, at p₁₅) can be used to hold the tip at the surface in order to improve the SNR when the tip is on the surface. Notably, while FIGS. 6A-6H illustrate examples of possible gating schemes, other gating schemes are possible; for example, multiple gates in an oscillation cycle.

Also, while single frequency operation may be employed, the preferred embodiments contemplate using frequency sweeps and frequency bands during gating, such as the band of frequencies illustrated in FIG. 5D. Similar to FIG. 5D, the goal is to collect data regarding the full oscillation frequency spectrum (not just resonance), over a wide frequency range.

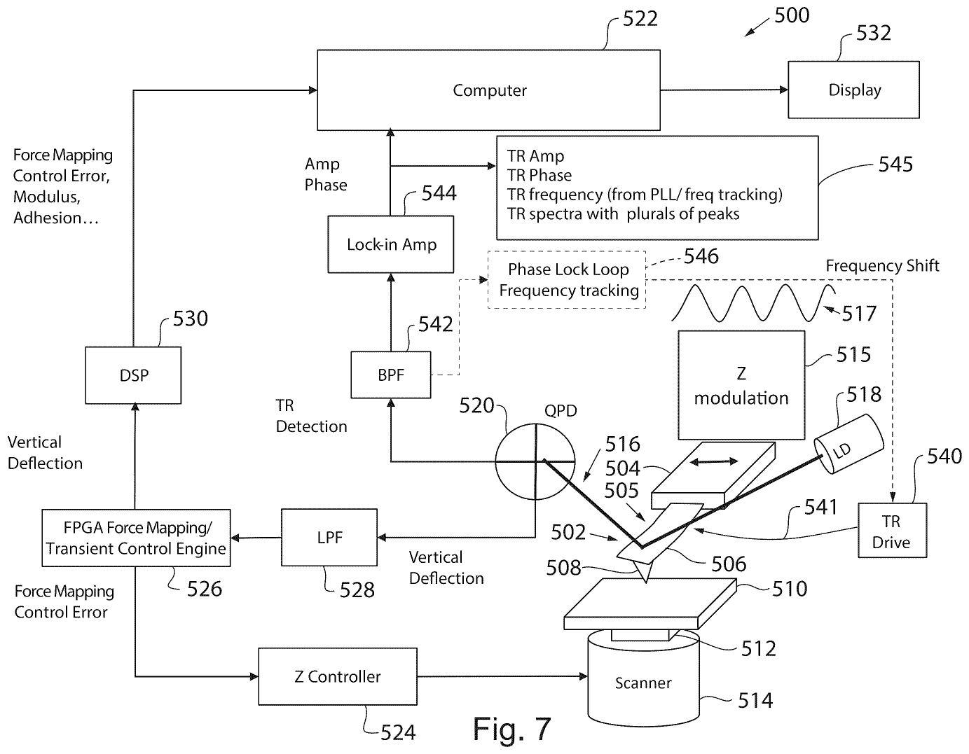

Turning next to FIG. 7, an AFM system 500 is shown schematically for implementing the preferred embodiments that employ, preferably, transient control feedback (PeakForce Tapping®, FastForce Volume (https://www.bruker.com/en/products-and-solutions/microscopes/materials-afm/afm-modes/force-volume.html), QI Mode (https://www.bruker.com/en/products-and-solutions/microscopes/bioafm/resource-library/qi-mode-quantitative-imaging-with-the-nanowizard-3-afm.html)) along with torsional resonance probe deflection sensing. A probe device/assembly 502 has a base 504 and a probe 505 including a cantilever 506 extending from base 504 and a tip 508 supported by the free end of the lever. Probe device 502 is mounted in an AFM head (not shown) and is positioned to engage a sample 510 supported by a sample holder 512 mounted on a scanner 514 (any suitable scanner, multi-directional (XYZ) or not). An optical beam bounce deflection detection system 516 including a laser source (e.g., laser diode) 518 and a quadrant photodetector (QPD) 520 provided to measure deflection of a cantilever 506 of probe assembly 502. A computer 522 implements both AFM control and torsional resonance sensing.

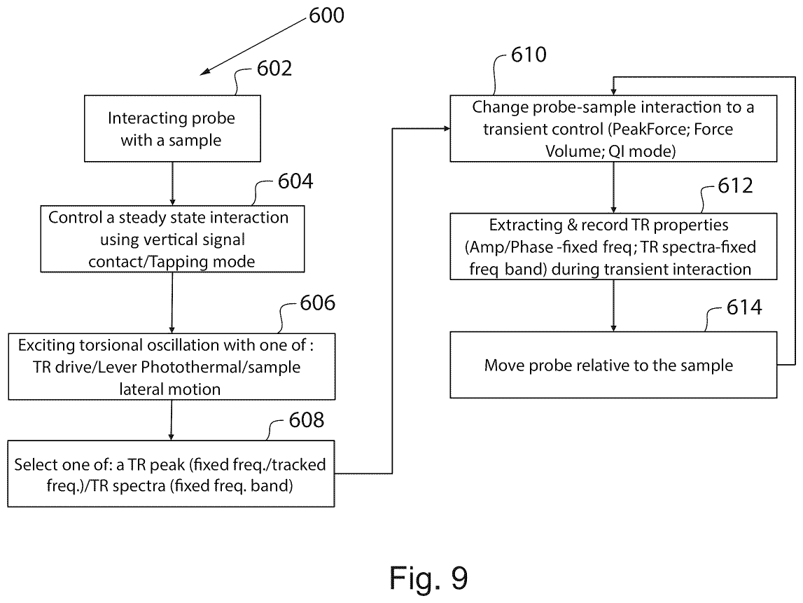

In this case, for AFM control, a Z modulation drive 515 generating an oscillating signal 517 is used to drive steady state interaction between the probe assembly 502 and sample 510 (for example, in steps 602-608 of method 600 of FIG. 9, described below). Z Drive 515 is used to drive any suitable actuator such as a piezo tube, self-actuated probe, or Z scanner or stage 514, and may be used to drive oscillation of either probe assembly 502 or sample 510, typically via a Z controller 524.

After selecting one of a TR peak or TR spectra (Step 608 of method 600, FIG. 9), the instrument 500 is ready to image a sample using transient mode feedback and TR sensing. The user first selects a transient mode using computer 522 which instructs Z controller 524 to modulate probe-sample separation to have tip 508 engage sample 510. As tip interacts with the sample in the selected transient mode, controller 524 maintains the set-point of operation according to that selected mode (e.g., PFT Mode). As photodetector 520 transmits vertical deflection signals to an FPGA (field programmable gate array) transient control engine 526 via a low-pass filter 528, FPGA 526 computes a control error signal to send to controller 524 to maintain tip-sample interaction at the mode setpoint by changing, in this case, the sample “Z” position. The transient control error signal is also sent to computer 522 via a DSP 530 for further processing, such as for viewing an image of the sample (PFT Mode control signals are indicative of sample properties, for example, modulus, adhesion, etc.) on a display 532.

In one embodiment, a torsional or TR drive 540 is gated to drive probe device 502 in torsion during a selected region of the force or deflection curve (see FIGS. 6A-6D) to sense changes in torsional resonance of probe device 502 in that region. The gated drive is triggered at the close proximity interval (FIG. 3) known in transient modes. The TR drive 540 can actuate the probe itself using any number of suitable sources, such as photothermal, electrostatic and electromagnetic actuation. Alternatively, the drive can be continuous and the detection can be gated, with one or more gating windows (selected region(s)) for example.

As the probe deflects in torsion, quad photodetector 520 outputs a torsional deflection signal and transmits the same to a band-pass filter 542. Band-pass filter (BPF) 542 transmits its output at the selected frequency range to a lock-in amplifier 544 for further processing of the amplitude and phase of the torsional resonance signal.

In an alternative embodiment, BPF 542 may transmit its torsional resonance signal to a phase lock loop (PLL) 546 to determine the frequency shift of the measured torsional resonance. The measured frequency shift may be sent to TR drive 540 for coupling an appropriate drive signal to probe 505 to maintain torsional oscillation of probe 505 at its setpoint. These signals are also processed by computer 522 and may be stored or displayed for further analysis by the user. TR drive 540 can be a photothermal, electrostatic or magnetic drive, for example.

The TR amplitude, TR Phase, TR frequency (from PLL/frequency tracking block 546) and TR spectra with a plurality of peaks (Block 545) may be analyzed to extract sample surface information as understood in the art. For example, sample properties can be gleaned from attractive forces (van der Waals, electrostatic, magnetic forces), while material properties can be gathered in response to sample expansion with photothermal nano IR using TR contact resonance, adhesion forces, etc.

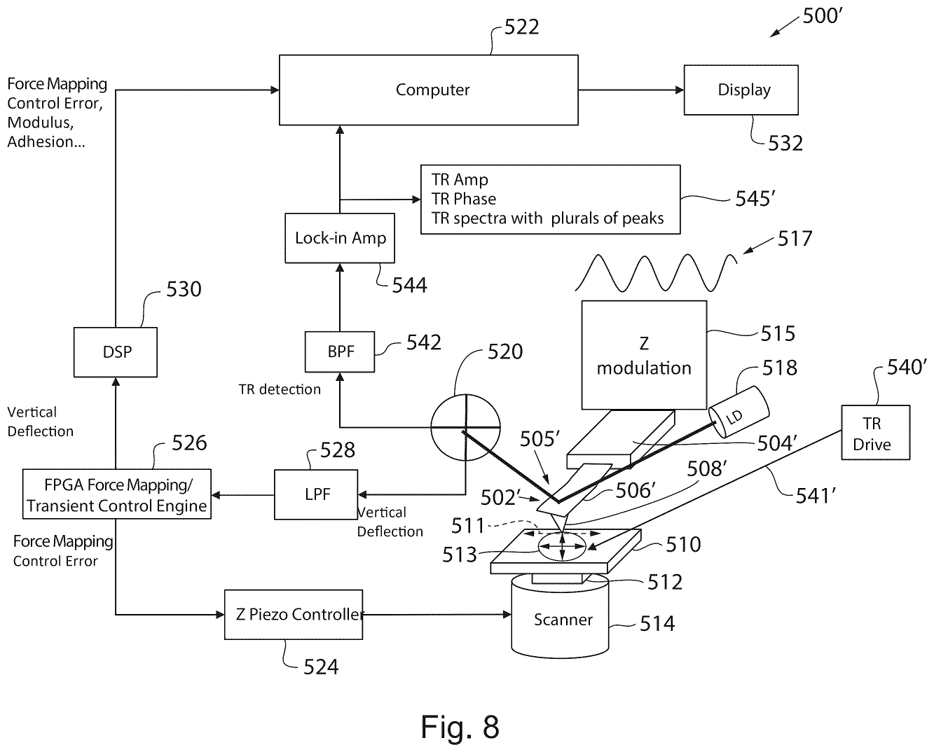

In an alternative embodiment shown in FIG. 8, drive 540′of a system 500′ can generate a signal (shown schematically as arrow 541′) applied locally to sample 510 to excite the sample (lateral motion shown by arrow 511) and instigate a torsional resonance of the probe assembly. More particularly, a probe device/assembly 502′ has a base 504′ and a probe 505′ including a cantilever 506′ extending from base 504′ and a tip 508′ supported by the free end of the lever. Probe device 502′ is mounted in an AFM head (not shown) and is positioned to engage a sample 510 supported by a sample holder 512 mounted on a scanner 514 (any suitable scanner, multi-directional (XYZ) or not). An optical beam bounce deflection detection system 516 including a laser source (e.g., laser diode) 518 and a quadrant photodetector (QPD) 520 provided to measure deflection of a cantilever 506′ of probe assembly 502′. A computer 522 implements both AFM control and torsional resonance sensing.

In this case, for AFM control, a Z modulation drive 515 generating an oscillating signal 517 is used to drive steady state interaction between the probe assembly 502′ and sample 510 (for example, in steps 602-608 of method 600 of FIG. 9, described below). Z Drive 515 is used to drive any suitable actuator such as a piezo tube, self-actuated probe, or Z scanner or stage 514, and may be used to drive oscillation of either probe assembly 502′ or sample 510, typically via a Z controller 524.

Again, a variety of sources can be used as drive including piezoelectric, photothermal, electromagnetic, acoustic/ultrasonic energy or an alternate drive mode like shear mode. In another embodiment, TR Drive 540′ can be a QCL tunable laser with mid-IR wavelength range directing IR radiation 541′ at sample 510. The repetition rate of the IR signal is chosen to match the TR frequency thereby causing surface displacement shown by arrows 513. Vertical displacement of probe has been used in such conventional IR systems, while the resulting lateral displacement of the probe in this case yields a TR response of the sensing probe.

Similar to the embodiment of FIG. 7 in which the probe itself is driven, after selecting one of a TR peak or TR spectra (Step 608 of method 600, FIG. 9, discussed below), instrument 500′ is ready to image a sample using transient mode feedback and TR sensing. The user first selects a transient mode using computer 522 which instructs Z controller 524 to modulate probe-sample separation to have tip 508′ engage sample 510. As tip interacts with the sample in the selected transient mode, controller 524 maintains the set-point of operation according to that selected mode (e.g., PFT Mode). As photodetector 520 transmits vertical deflection signals to an FPGA (field programmable gate array) transient control engine 526 via a low-pass filter 528, FPGA 526 computes a control error signal to send to controller 524 to maintain tip-sample interaction at the mode setpoint by changing, in this case, the sample “Z” position. The transient control error signal is also sent to computer 522 via a DSP 530 for further processing, such as for viewing an image of the sample (PFT Mode control signals are indicative of sample properties, for example, modulus, adhesion, etc.) on a display 532.

As the probe deflects in torsion, quad photodetector 520 outputs a torsional deflection signal and transmits the same to a band-pass filter 542. Band-pass filter (BPF) 542 transmits its output at the selected frequency range to a lock-in amplifier 544 for further processing of the amplitude and phase of the torsional resonance signal.

The preferred embodiments exploit the advantages of known AFM operating modes, preferably transient modes such as PFT Mode, QI Mode and FastForce Volume modes described herein, including AFM operating speed and resolution, along with the advantages torsional resonance mode (TR Mode) including its robustness in the presence of AFM system noise. AFM performance improves with respect to imaging speed and atomic level resolution, including the capability to distinguish atoms of select samples (graphite, mica, 2D materials, etc.). Moreover, the preferred embodiments can be expanded to improved AFM performance when using other AFM techniques. For instance, multi-frequency techniques can be used in connection with the preferred embodiments to exploit resonance harmonics for topographical feedback in amplitude modulation (AM) along frequency-modulated (FM) harmonics (flexural and torsional) using Lock-in amplifier and phase-locked-loop (PLL) electronics. Higher flexural harmonics may be used for atomic resolution imaging (higher stiffness than lower harmonics). Improvement in performance can also be achieved in a variety of AFM sample measurement experiments, including for example mechanical property measurement (PeakForce QNM), electrical measurements, IR based measurements, and others.

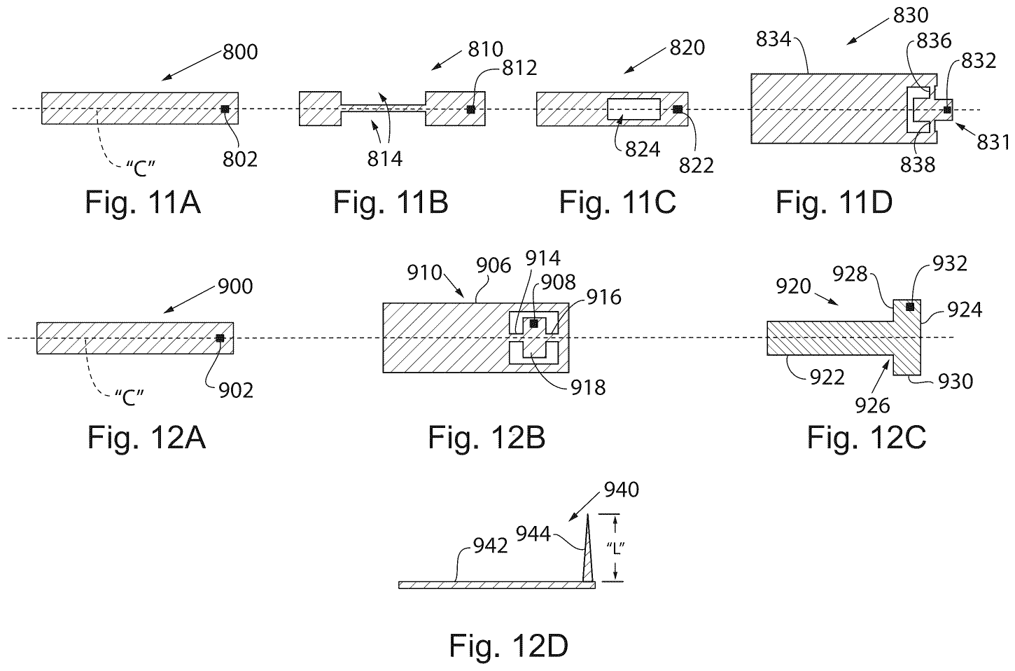

Moving to FIG. 9, a method 600 of operating an AFM according to the preferred embodiments is shown. After selecting a probe (e.g., shape and tip offset shown in FIGS. 11A-D- and 12A-D, as discussed below) optimized for intended oscillation (e.g., at resonance, flexural/torsional), the AFM interacts the probe with the sample in Step 602. Next, in Step 604, method 600-operates the AFM in a steady-state control scheme using conventional methods (e.g., contact or Tapping Mode). Then, method 600 excites a torsional oscillation of the probe using an appropriate drive in Step 606, for example, a torsional resonance or TR drive applied to the lever of the probe or a photothermal drive to instigate sample lateral motion. These drives are discussed further above in connection with preferred embodiments of the AFM shown in FIGS. 7 and 8. Then the method may select one of a TR peak (fixed frequency or tracked frequency) or a TR spectra (fixed frequency band) in Step 608.

The AFM mode of operation is then changed to a force mapping or transient mode in Step 610, i.e., PFT Mode, QI-Mode or Force Volume Mode. The close proximity interval is determined (see FIG. 3) using the precise force control data provided by the transient modes of AFM operation. The close proximity interval provides sample property information from the torsional responses such as amplitude, phase and frequency shift and TR spectra. In Step 612, method 600 extracts and records TR properties such as amplitude and phase at a fixed frequency, or TR spectra using a frequency sweep or at a fixed frequency band during transient interaction (i.e., the close proximity interval per FIGS. 6A-6G). Finally, in Step 614, method 600 determines whether more probe-sample locations should be imaged. If so, during the interaction free interval, probe-sample position is moved laterally in a scanning step to acquire sample data at a different location, and steps 610 to 614 are repeated until the sample area of interest has been scanned.

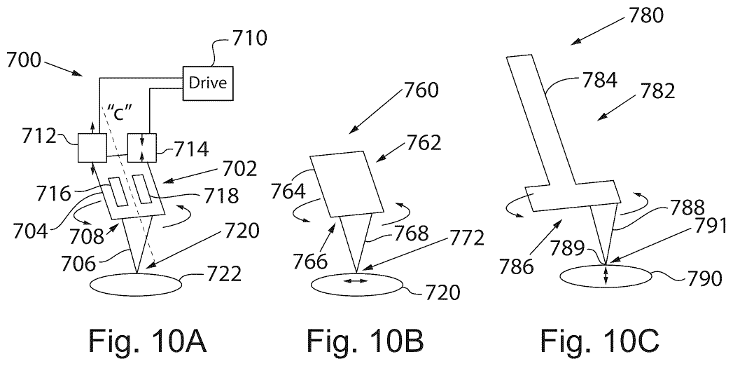

Next, there are several ways to drive the gated TR excitation. FIG. 10A discloses a set-up 700 to excite TR resonance by driving either side of the longitudinal centerline “C” of a cantilever 704 of a probe 702 with, for example, equal and opposite “Z” signals 712, 714 using a drive 710. “Z” signals may be periodic signals applied to piezoelectric elements 716, 718 disposed on-board probe 702 on either side of the cantilever centerline “C.” This provides coordinated movement of opposites sides of cantilever 714 up and down which translates to torsional movement of a probe tip 706 supported at a distal end 708 of lever 704 at the proximate contact point 720 between probe tip 706 and a sample 722.

According to another set-up and method 760 to drive torsional excitation of the preferred embodiments, shown in FIG. 10B, the sample is moved relative to a probe 762 having a cantilever 764 with a distal end 766 supporting a tip 768. More particularly, as probe-sample interaction is modulated (for example, in PFT Mode) the proximate contact interval is determined and torsional excitation is initiated, in gated fashion, to coincide with the contact interval, by causing lateral motion of the sample. Gated periodic lateral motion of a sample 770 (shown with doubled ended arrow) provided by a source coupled to an actuator (not shown) causes a torsional resonance in probe 762 by coupling the periodic motion from sample 770 to probe tip 768 when the two in proximate contact (point 772) as described previously. Changes in this torsional resonance can be detected using deflection detection to determine sample properties. Notably, the drive can be any suitable drive such as piezoelectric, thermal, photothermal, etc. Lastly, in FIG. 10C, the torsional oscillation in the probe may be created using a set-up 780 including a probe 782 having a cantilever 784 with a distal end 786 (symmetric or asymmetric cantilever geometry) configured to accommodate an offset tip 788. In this case, the sample 790 may be driven vertically (in “Z”) to correspondingly cause cantilever 784 to rotate about its longitudinal center axis when an apex 789 of tip 788 and sample 790 are at a proximate contact point 791 known, ideally, from using a transient AFM control method such as PFT Mode.

Also important to achieving high sensitivity and signal amplification in the technique of the preferred embodiments is the AFM sensing probe. FIGS. 11A-11D show cantilevers for detecting flexural resonance having varying shapes (including, for example, symmetric or asymmetric cantilever geometry)—typically, for AFM control. In FIG. 11A, a standard “diving board” cantilever 800 has a longitudinal center line “C.” Cantilever 800 includes a distal end supporting a tip 802 position along center “C.” FIG. 11B is a probe having a cantilever 810 supporting a tip 812 with a similar design, but in this case symmetric portions 814 are removed depending on application/user needs (smaller spring constant, etc.). FIG. 11C shows a cantilever 820 supporting a centerline tip 822 similar to the previous two, but in this case the probe is fabricated to include a cut-out 824 inward of the distal end. FIG. 11D illustrates a cantilever 830 having a distal end supporting a centerline tip 832 but in this case cantilever 830 has a wider stiff portion 834 using arms 836, 838 extending orthogonally to centerline “C” to couple lever 831 (less stiff) to portion 834. Lever 831 rotates about the arms to move the tip in “Z.” All these probes/cantilevers are microfabricated according to the user's needs—resonant frequency, spring constant, sample type and measurement, etc.—to help amplify the deflection signal and improve AFM performance. Some benefits include, for example, the probes in FIGS. 10B and 10C would have low torsional spring constant. The FIG. 10D probe can measure the torsional response in the vertical direction.

Turning to FIGS. 12A-12D, a series of cantilevers are schematically illustrated with various shapes and tip offsets, particularly adapted for detection of torsional resonance. FIG. 12A is a standard “diving board” type cantilever 900 supporting a tip 902 at a centerline “C” of cantilever 900. In FIG. 12B, a cantilever 910 similar to the one shown in FIG. 11D is illustrated. However, a pair of arms 914, 916 of a hinge extend along the longitudinal centerline “C” of a stiff portion 906 of the lever 910 to couple the sensitive lever portion 918 to stiff portion 906, instead of orthogonal thereto. As tip 908 interacts with the sample (not shown) portion 918 torsionally rotates about the centerline “C.” In FIG. 12C, a cantilever 920 includes an elongate portion 922 and a wide portion 924 disposed orthogonally at a distal end 926 of cantilever 920. Wide portion 924 has opposed ends 928, 930, preferably one of which supports a tip 932. As tip 932-interacts with a sample (not shown) this offset causes cantilever to oscillate in torsion when the two are at the proximate contact point. Some benefits include, for example, the FIG. 12B and FIG. 12C probes with their offset tip can increase the moment arm to improve torsional sensitivity. FIG. 12D is a schematic side view of a probe 940 including a cantilever 942 supporting a tip 944 having a high aspect ratio. With careful choice of tip length “L” a range of lateral motion can be achieved using each of the above-described probe designs. Similar to the FIG. 12B and 12C probes, the L-shape probe with offset tip can increase the moment arm and improve the torsion measurement sensitivity. And comparing to a T-shaped probe, the cantilever has less mass, increasing the resonance frequency.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. A method of operating a scanning probe microscope (SPM) having a probe device including a tip that interacts with a sample, the method comprising:
controlling interaction between the probe device and the sample using a steady state SPM operating mode;
exciting torsional oscillation of the probe device by driving at least one of the probe device and the sample;
selecting at least one of a torsional oscillation frequency, a torsional oscillation frequency sweep and a torsional oscillation frequency band;
switching control of the interaction between the probe device and the sample to a force mapping control mode;
during transient interaction in the force mapping control mode, driving the torsional oscillation of the probe device from the exciting step based on the selecting step;
measuring a torsional oscillation response during the driving step; and
extracting a sample property based on the torsional oscillation response.

2. The method according to claim 1, wherein the force mapping control mode is one of PeakForce Tapping Mode, QI Mode and Force Volume Mode.

3. The method according to claim 1, wherein the exciting step includes driving one of the probe device and the sample using a torsional oscillation drive using at least one of a photothermal, electrostatic and electromagnetic actuation.

4. The method according to claim 1, wherein the exciting step moves the sample inducing torsional motion of the probe device.

5. The method according to claim 4, wherein the probe device has at least one of an offset tip disposed asymmetrically to a longitudinal centerline of a cantilever of the probe device, and an asymmetric cantilever geometry.

6. The method according to claim 1, wherein the measuring step generates a signal, and the signal is amplified by at least one of the shape of the probe and an offset of a tip of the probe from a longitudinal centerline of a cantilever of the probe.

7. The method according to claim 1, wherein the selecting step includes selecting a torsional resonance, wherein the sample has a surface with a hardness, and wherein the selected torsional resonance is greater the harder the sample surface.

8. The method according to claim 1, further comprising gating one of the driving step and the measuring step to a proximate contact point corresponding to a selected region of the force mapping mode force curve.

9. The method according to claim 8, wherein the selected region includes more than one selected region.

10. The method according to claim 8, wherein the selected region corresponds to the sample property.

11. The method according to claim 10, wherein the sample property is adhesion.

12. The method according to claim 8, wherein the selected region corresponds to one of an approach, a hold and a withdraw.

13. The method according to claim 1, wherein the driving step drives the probe at a torsional resonance in TR Mode.

14. The method according to claim 1, wherein the probe and the sample do not contact each other during the interaction between the probe and the sample in the transient control mode.

15. The method according to claim 1, further comprising providing scanning motion between the probe device and sample to measure sample properties at a plurality of sample locations.

16. A scanning probe microscope (SPM) having a probe device including a tip that interacts with a sample, the SPM comprising:
a drive to provide relative oscillation between the probe device and the sample;
a controller to control the interaction between the probe device and the sample;
a torsional oscillation drive to oscillate the probe device; and
a computer to:
select at least one of a torsional oscillation frequency and a torsional oscillation frequency band while operating the SPM in a steady state SPM operating mode;
switch control of interaction between the probe device and the sample to a transient control mode;
during transient interaction, causing the drive to drive torsional oscillation of the probe device based on a selected torsional oscillation frequency and torsional oscillation frequency band;
determine a torsional oscillation response while driving torsional motion; and
extract a sample property based on the torsional oscillation response.

17. The SPM according to claim 16, wherein the transient control mode is one of PeakForce Tapping Mode, QI Mode and Force Volume Mode.

18. The SPM according to claim 16, wherein the torsional oscillation drive moves the sample inducing torsional motion of the probe device.

19. The SPM according to claim 16, wherein the computer generates a signal from the torsional oscillation response, and the signal is amplified by at least one of the shape of the probe and an offset of a tip of the probe from a longitudinal centerline of a cantilever of the probe.

20. The SPM according to claim 16, wherein one of driving the torsional oscillation and determining the torsional oscillation response is gated to a proximate contact point corresponding to a selected region of the transient mode force curve.

21. The SPM according to claim 20, wherein the selected region corresponds to one of an approach, a hold and a withdraw.

22. The SPM according to claim 20, wherein the selected region is more than one selected region.

23. The SPM according to claim 16, wherein the drive is a TR Mode drive and the probe device oscillation is at a resonance of the probe device.
